(19) United States
(12) Patent Application Publication
(10) Pub. No.: US 2011/0101588 A1
(43) Pub. Date: May 5, 2011

(54) SLIDING DRILL PRESS

(76) Inventors: Aaron St. Pierre, Jay, ME (US); Norman St. Pierre, Wilton, ME (US)

(21) Appl. No.: 12/611,406

(22) Filed: Nov. 3, 2009

(51) Int. Cl. B23Q 3/00

(52) U.S. Cl. 269/290

(57) ABSTRACT

The present invention is directed to an apparatus for receiving a cylindrical workpiece and centering that workpiece on a central axis of an elongated support frame. An overhanging machine slides along parallel rails spaced equidistantly from the central axis and enables a machine bit aligned with the central axis to contact the cylindrical workpiece at points located precisely along its apex. Because the machine is moveable relative to the stationary workpiece, the apparatus eliminates a need complex fixturing and increases throughput while enabling repeated accurate alignment of a moving machine bit with the apex of the cylindrical workpiece centered on and lying along the central axis.

### BACKGROUND

1. Field of the Invention

The present invention relates generally to a machining apparatus and more specifically to a sliding press for milling, drilling, reaming and routing a cylindrical workpiece along its longitudinal axis and with zero degrees of lateral deflection from the longitudinal axis of the workpiece.

2. Discussion of Background Information

Drilling, milling, or routing material from a long cylindrical workpiece, such as a heavy steel pipe or PVC tubing, can be expensive and time consuming. Achieving a high degree of accuracy with regard to aligning a moving machine bit with one or more targets on a cylindrical workpiece presents a substantial challenge and typically requires orienting and affixing a workpiece to a machine table prior to each operation.

For example, drilling holes in a long, heavy pipe cylindrical pipe presents one such challenge. Typically, a machinist must affix the workpiece to a standing drill press table so that the drill bit aligns perfectly with the pipe surface at a desired location. This may require measuring along the length and diameter of the pipe to determine the desired drilling location, pre-scoring the target with a center punch, and then eyeballing the alignment of the drill bit with the target. Depending on the length and flexibility of the pipe, a machinist may need to align additional support fixtures to balance the length of the pipe and maintain the drilling surface in alignment with the drill press table. Once the target is aligned and a hole is drilled, the machinist must then release the pipe from the work table, locate and center punch the next desired drilling location, and then reorient and re-affix the pipe and additional support fixtures. These repetitive steps reduce efficiency and increase opportunities for error with regard to alignment of each hole with a desired location and/or alignment of each hole relative to one or more other drilled holes positioned along the surface of the cylindrical workpiece.

For improved accuracy, a machinist may prefer to machine a cylindrical workpiece using a computer numerical controlled (CNC) machine. CNC machines are highly accurate and efficient but are relatively expensive to procure and operate, as compared to a standard drill press or milling machine. CNC machines also require an elevated level of skill for pre-programming the desired machine path along the length of a workpiece.

Most apparatuses for machining long cylindrical workpieces are stationary devices incapable of portability. Typically, drill presses and CNC machines are affixed to flooring and/or are too cumbersome to port. Furthermore, existing apparatuses for machining cylindrical workpieces typically provide no mechanism for automatically centering the workpiece beneath a bit. Furthermore, some apparatuses with moving machinery thereon enable movement of the machinery in two axes, allowing for increased bi-lateral slippage and deviation from exact alignment of the machine bit from a target location.

All of these existing methods are inaccurate, time consuming, cumbersome, and/or costly. A need therefore exists for a portable and efficient assembly that enables a machine to move in one direction along the length of a cylindrical workpiece to accurately place machined holes and slots with maximum efficiency.

### SUMMARY OF THE INVENTION

The present invention solves the problems associated with drilling, milling, reaming and routing material from a cylindrical workpiece and provides an apparatus for efficiently and repeatedly positioning a machining device at the apex of a stationary cylindrical workpiece. The apparatus comprises a trough shaped support frame and at least one cradle thereon wherein the longitudinal axis of the support frame aligns with the longitudinal axis of the at least one cradle. The at least one cradle is adapted to receive thereon a cylindrical workpiece, and the at least one cradle is shaped and positioned so as to automatically align the longitudinal axis of the cylindrical workpiece with the longitudinal axis of the support frame.

The apparatus further comprises a pair of parallel rails affixed to the sidewalls of the trough shaped support frame, and the parallel rails also extend parallel to and equidistantly from the longitudinal axis of the support frame. A symmetrically shaped concave arcuate support member extends between the pair of parallel rails, terminating in a rail bearing means on each end for slidably engaging each respective rail. The support member is adapted to receive a machine thereon having a rotating bit centered at the apex of the support member and aligned with the longitudinal axes of the support frame, the cylindrical workpiece, and the at least one cradle.

### BRIEF DESCRIPTION OF THE DRAWINGS

One will better understand these and other features, aspects, and advantages of the present invention following a review of the description, appended claims, and accompanying drawings:

FIG. 1 depicts a cross-sectional end view of one embodiment of the apparatus of the present invention.

FIG. 2 depicts a perspective view of one embodiment of a portion of the apparatus of the present invention.

### DETAILED DESCRIPTION

The present invention solves the problems associated with drilling, milling, reaming, routing, etc. a long cylindrical workpiece, such as steel tubing or PVC pipe. In particular the present invention addresses inefficiencies and inconveniences associated with fixture clamping and accurately machining such long, cumbersome cylindrical workpieces. Although the apparatus of the present invention may employ any number of machines thereon, for purposes of simplicity, the following detailed description will refer to a drill press for drilling holes in a cylindrical pipe.

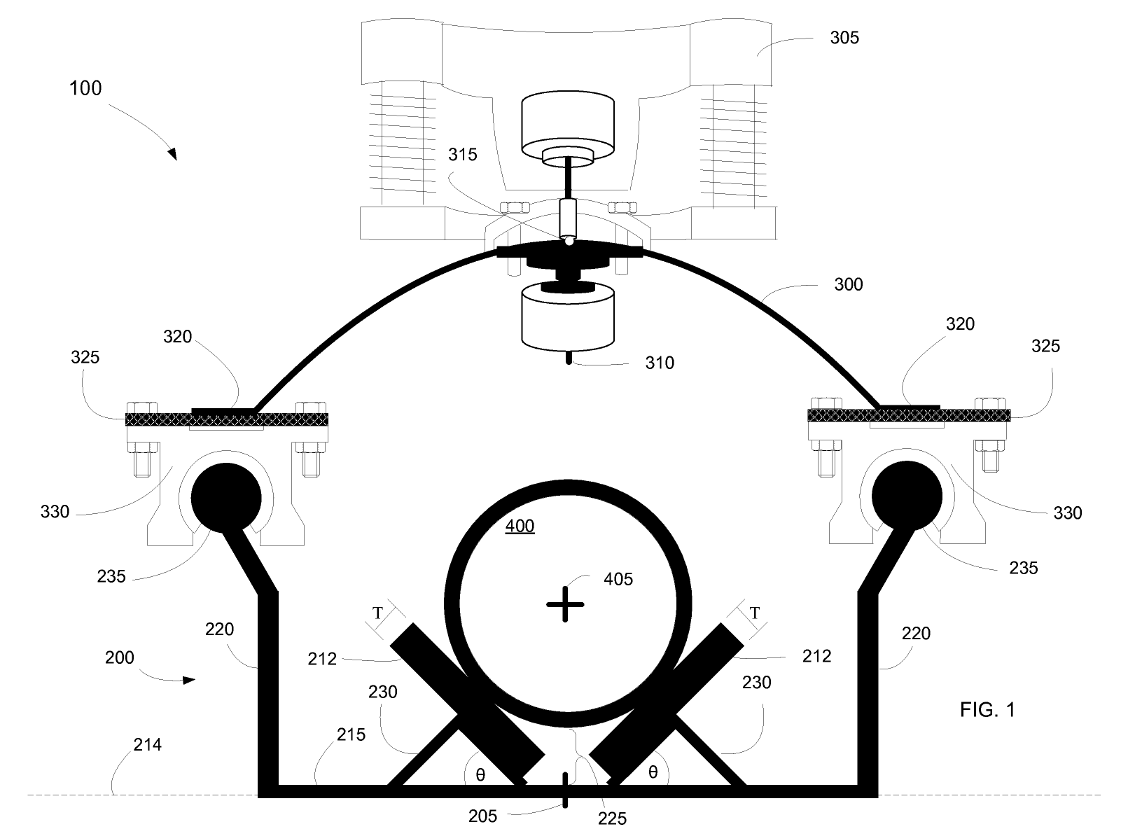

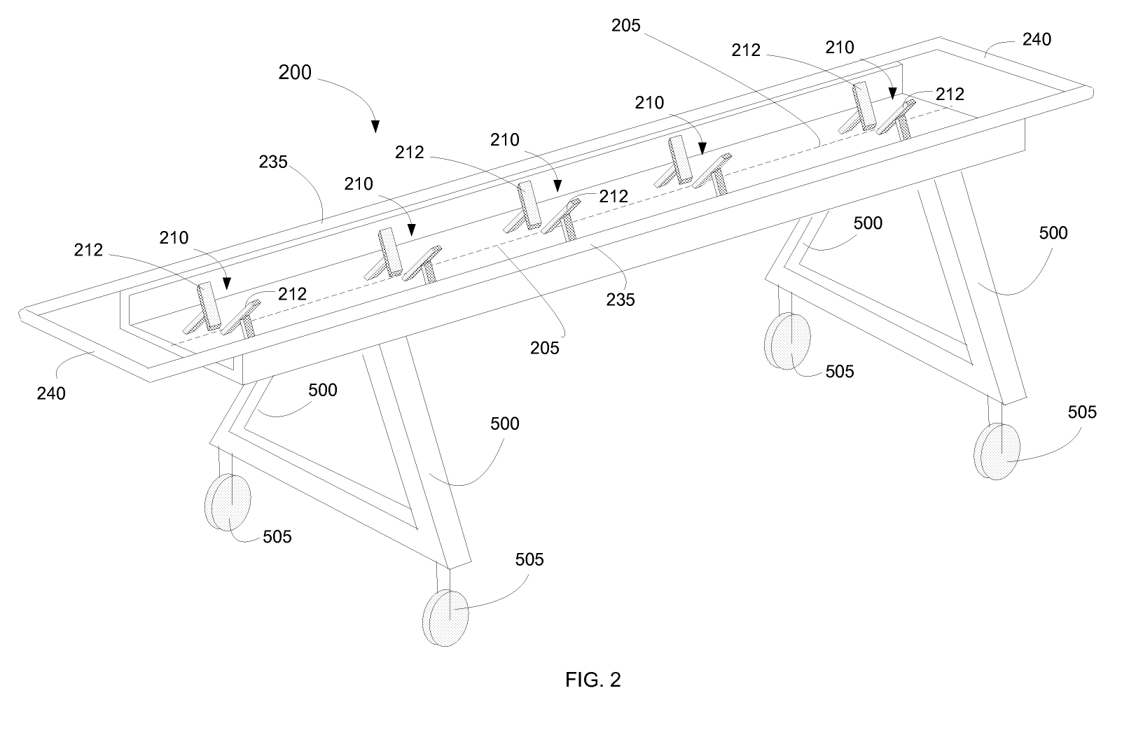

FIGS. 1 and 2 depict one embodiment of the apparatus 100 of the present invention for positioning a machining device at the apex of a stationary cylindrical workpiece. The apparatus 100 comprises a support frame 200 having a symmetrical cross section and a longitudinal central axis 205 along which one or more cradles 210 are disposed. The one or more cradles 210 are centered in exact alignment with the central axis 205 of the support frame 200. In the embodiment depicted in FIGS. 1 and 2, the support frame 200 is trough shaped with a horizontally oriented flat bottom 215 and two sidewalls 220 rising perpendicularly therefrom. The bottom 215 and sidewalls 220 catch and entrap all material cast off during machining operations, such as metal shavings created while drilling holes in a steel pipe.

The support frame 200 may take any number of alternate shapes. For example, the sidewalls 220 might rise at an angle from the bottom 215 rather than rising perpendicularly from that surface. The sidewalls 220 thus may be angled inward or outward, toward or away from the central axis 205 as long as they remain equidistant from the central axis 205. In another embodiment, the bottom 215 of the support frame may have a V-shaped cross section so that the apex of the “V” aligns with the central axis 205 and the wings of the “V” are sloped inward at the same angle. In this way, a pipe 400 placed in the support frame 200 will roll to the central axis 205 and settle thereon, perfectly constrained about the central axis by the sloping wings of the V-shaped bottom 215. This embodiment would eliminate the need for one or more separately applied cradles 210 because the entire length of the support frame 200 would serve to cradle and support a lengthy pipe 400. Another embodiment (not shown) may employ a support frame 200 having a bottom 215 and open sides bounded by railing-like elements anchored to the ends of the support frame 200 and spanning the length of the support frame 200 parallel to the central axis 205. Again, the as long as the railing-like elements remain equidistant from the central axis 205 and parallel to the central axis 205, the apparatus 100 of the present invention will function as designed to maintain proper alignment between critical elements as herein further described.

As shown in the embodiment of FIGS. 1 and 2, the support frame 200 comprises a plurality of cradles 210 disposed thereon at even increments to provide balanced support along the length of a pipe 400. In an alternate embodiment, the cradles 210 may lie at uneven increments to provide more support in particular locations. For example, some portion of the cradles 210 may bunch together towards the ends of the support frame 200 to support a pipe having thicker, heavier walls or heavy transition elements at either or both ends. In yet another embodiment, the cradle 210 may be one long cradle 210 disposed on the support frame 200 for supporting the pipe 400 thereon and aligning the longitudinal pipe axis 405 with the central axis 205.

Returning now to the embodiment of FIGS. 1 and 2, the one or more cradles 210 are substantially V-shaped, with opposing wings 212 sloping downward toward the central axis 205. The opposing wings 212 are equidistant from the central axis 205 and are sloped at the same angle θ from horizontal 214. In a preferred embodiment, the opposing wings 212 are angled between 20 and 80 degrees from horizontal 214 and more particularly at 45 degrees from horizontal. In some embodiments, the slope of the wings 212 may be adjustable to accommodate pipes 400 having large diameters overall or at certain locations along their lengths. In other embodiments, the wings 212 may be adjustable so that they extend further upward but at a steady angle from horizontal 214. The angle θ of the wings 212 is variable as long as the wings 212 of each individual cradle 210 are spaced equidistantly form the central axis 205 and are positioned at the same angle θ from horizontal 214. The one or more cradles 210 therefore automatically center the pipe 400 therein by design. Gravity and the angled, equidistantly spaced wings 212 center the pipe 405 around the central axis 205 so that the longitudinal pipe axis 405 is parallel to the central axis 205 of the support frame 200.

In certain embodiments the one or more cradles 210 are affixed to the support frame 200 so as to prevent any movement and so as to withstand forces applied while machining a pipe 400 positioned in the one or more cradles. For example, in certain embodiments, the one or more cradles 210 may be bolted or welded to the bottom 215 of the support frame 200. In other embodiments, the one or more cradles 210 may be selectively secured with set screws or magnets, for example. Allowing selective locking enables a machinist to space the one or more cradles 210 in any configuration along the central axis 205 and thereby provide additional support along certain portions of a length of pipe 400.

In the embodiment of FIGS. 1 and 2, the wings 212 of the cradles 210 are substantially flat faced elements. In other embodiments, the wings 212 may comprise surface topography for increasing friction between the wings 212 and a pipe 400 thereon during machining operations. Such topography assists with reducing any movement caused by vibrations and thereby reduces the likelihood that the moving machine bit would wander from the desired target on the pipe 400. The faces of the wings 212 may be peened, sandblasted, coated with grit, or etched, for example, as long as the faces are treated equally and to the same degree so that the outermost surface layers of the wings 212 of a cradle 210 remain equidistant from the central axis 205 at every matching point along their lengths. This ensures that a pipe 400 thereon will be perfectly centered on the central axis 205 so that the longitudinal pipe axis 405 aligns with and lies parallel to the central axis 205.

In addition to providing secure seating during machining operations to counteract any torsional and vibration forces, certain embodiments of the one or more cradles 210 allow for drilling through the entire pipe so that both the upper apex and lower apex are drilled. The embodiment of FIGS. 1 and 2 allows for such an operation. As FIG. 1 clearly depicts, the wings 212 of the one or more cradles 210 have a gap 225 between them at their lower edges. This gap 225 allows for through hole drilling of the wall of the pipe 400 at the lower apex. In the embodiment depicted in FIG. 1, the substantially flat wings 212 of the cradle 210 are raised above the bottom 215 of the support frame 200 by a pair of risers 230. The pair of risers 230 may be integrally formed with the wings 212 or permanently secured thereto through some affixing means such as welding, bolting, epoxy bonding, etc. In any case, the risers 230 are identically shaped so that the wings 212 remain at a constant angle θ from horizontal 214 and so that the wings 212 are equidistant from the central axis 205 at all mirrored points along their lengths. The gap 230 is further created by the wings 212 themselves which comprise a thickness T that further elevates their pipe contact surfaces from the bottom 215 of the support frame 200.

In addition to a support frame 200 having one or more cradles 210 disposed thereon, the apparatus 100 of present invention further comprises a support member 300 adapted for receiving a machine 305 thereon, such as a Rigid® HC-300 drill press. In the embodiment depicted in FIG. 1, the drill press 305 is mounted and secured to the support member 300 so that the machine bit 310 aligns with the central axis 205 of the support frame and therefore also aligns with the longitudinal pipe axis 405. The support member 305 is an arcuate member disposed above the one or more cradles 210 and symmetrically curved about the central axis 205. In the embodiment of FIG. 1, the arcuate support member 305 is oriented concave down so that any forces applied during machining are counteracted by the radial compression strength of the arcuate support member 305. The drill press 305 is centered on the support member apex 315 so that the support member apex 315, the machine bit 310, the longitudinal pipe axis 405 and the central axis 205 are all in parallel alignment.

The support member 300 may be fabricated from any stiff, strong material capable of withstanding torsional and linear forces applied during machining operations so that the moving bit never deviates from alignment with a target on the apex of the pipe 400. For example, in one embodiment, the support member 300 may be formed from a bent strip of 1.5 inch wide and 0.5 inch thick angle iron. Bending deforms the strip of angle iron and induces internal stresses, but no deformation occurs beyond the yield strength of the crystalline structure. Instead, bending a strip of material to form the arcuate support member 300 creates compression forces in the lower surface and tension forces in the upper surface of the support member 300. These inherent forces resist forces generated by the drill press 305 during machining operations.

In addition to having an arcuate curvature, the support member 305 slidably mounts to the support frame 200 for movement in the direction of the longitudinal axis only. In the embodiment of FIG. 1, the support member 300 terminates at each end in a flange 320. Each flanged end 320 of the support member 300 is rigidly affixed to support plates 325 that are bound to bearing members 330. In some embodiments, the support member 305 comprises a single strip of bent stock. In other embodiments, the support member may comprise more than one strip of bent stock, in which embodiments, additional bearing members 330 and support plates 325 would be incorporated accordingly. Adding additional support members 300 beneath the drill press 305 would increase stability to prevent any deflection of the moving bit 310.

Returning to the embodiment of FIG. 1, the bearing members 330 are linear bearings slidably engaged with a pair of parallel rails 235 that are respectively mounted along the opposing sidewalls 225 of the support frame 200. The parallel rails are affixed to the sidewalls 225 through some mechanical means such as but not limited to welding, screwing, clamping, nailing, riveting, and gluing. The rails 225 are positioned at even heights from the bottom 210 of the support frame 200 and at even distances from the central axis 205. This ensures that the arcuate support member 300 is centered on the central axis 205. Because the sidewalls and rails 235 are equidistant from the central axis 205, the bit 310 remains perfectly aligned with the longitudinal pipe axis 405 as the support member 305 slides along the rails 235.

The pair of rails 235 may be made of any round stock and preferably from a polished stock that allows for smooth movement of the bearing members 330. For example, in the embodiment depicted in FIG. 2, the pair of parallel rails 235 are 24 foot lengths of 1.25 inch diameter polished round stock. The pair of rails 235 extend beyond the ends of the support frame 200 so that the drill press 305 may slide out of the path of a pipe 400 during loading and unloading onto the apparatus 100. The apparatus 100 further comprises cross members 240 attached to the pair of parallel rails 235 to prevent the support member 300 from sliding past the ends of the rails 235 and disengaging from the apparatus 100. In some embodiments, the apparatus 100 may further comprise a braking system for halting travel of the support member 305 during drilling. This further adds to the stability of drilling a hole at a target location with zero deviation. The rails system therefore constrains travel of the support member 300 to longitudinal motion with no lateral movement. This configuration insures zero deviation of the moving drill 310 from the drill target on the apex of the pipe 400.

Because the drill press 305 moves relative to a stationary pipe 400 therebeneath, and because the drill bit 310 and target locations on the apex of the pipe 400 are automatically precisely aligned by virtue of the pipe 400 resting in the one or more cradles 210, the apparatus 100 enables efficient and accurate drilling at points along a linear path at the apex of the stationary pipe 400. In one trial, the apparatus 100 averaged a 1.8 minute per hole drill time whereas a standard drill press averaged 4.03 minutes per hole. This trial demonstrated that the apparatus 100 of the present invention provides a 55% increase in efficiency over standard drilling methods.

In addition to providing increased efficiency, the present invention also provides improvements in ergonomics and portability. Because the apparatus 100 eliminates a need for affixing, releasing, repositioning and re-affixing a pipe to a fixture or drill press table between operations, a machinist need not wrestle with positioning a heavy length of pipe repeatedly. Instead, a machinist using the present invention may employ ergonomic cranes to lift a heavy pipe onto the apparatus 100 just one time. The sliding support member 300 moves relative to the stationary pipe 400 which is precisely positioned therebeneath without any extensive measurement or fixture jigs required for proper alignment.

In some embodiments, the apparatus 100 comprises legs 500 extending from the underside of the support frame 200 and terminating in wheels 505 which may be locking and/or swivel wheels. This configuration enables a machinist to easily move the apparatus 100 to a convenient location for machining a workpiece and prevents the machinist from having to lug heavy pipes 400 from remote locations to a stationary apparatus 100. This greatly reduces travel time and stress related injuries associated with lifting and repositioning heavy pipes. In some embodiments, the legs 500 may extend upward and downward to facilitate loading and unloading a heavy pipe 400 with easy and to enable an operator raise the loaded apparatus 100 to a comfortable, ergonomic working height.

The apparatus 100 comprises elements constructed easily from simple materials. For example, the support frame 200 may be manufacture from conveniently procured and low cost rigid materials such as but not limited to wood, cement, metal, plastic and rubber. The bottom 215 and sidewalls 220 may be welded together, bolted, glued, or riveted for example, or the entire support frame 200 may be manufactured as an integrated unit. For example, the support frame 200 may be extruded, heat formed, molded or cast to take its final shape. Similarly, the one or more cradles 210 may be manufactured from conveniently procured and low cost rigid materials such as but not limited to wood, cement, metal, plastic and rubber. Preferably, the elements of the apparatus 100 will be manufactured from materials capable of achieving a high tolerance and using exacting methods of manufacture so that the central axis 205 aligns perfectly with the apex 315 of the support member 300, the drill bit 310 and the longitudinal axis 405 of the pipe 400 seated in the one or more cradles 210.

Because the apparatus 100 comprises standard materials and few moving parts, the overall cost of manufacture is relatively low compared to a standard drill press or CNC machine, for example. Furthermore, the apparatus 100 requires no extensive training to operate and the only consumables associated with the present invention are electricity for powering the drill press 305 and any lubricant applied to the moving drill bit 310. Therefore, in addition to being ergonomic and portable, the apparatus 100 of the present invention enables reliable and efficient operations at relatively low cost.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

I claim:

1) An apparatus for positioning a machining device at the apex of a stationary cylindrical workpiece comprising:
a) a trough shaped support frame having a symmetrical cross section and a longitudinal central axis along which at least one cradle is disposed for receiving the cylindrical workpiece and thereby aligning the longitudinal axis of the cylindrical workpiece with the longitudinal central axis of the support frame;
b) a pair of parallel rails affixed to the sidewalls of the trough shaped support frame parallel to central axis of the support frame and equidistant from the longitudinal axis of the cylindrical workpiece;
c) an symmetrical concave arcuate support member adapted for receiving a machine thereon, wherein the machine bit is centered at the apex of the support member and proximate the apex of the stationary cylindrical workpiece therebeneath, and wherein the support member terminates at each end in a rail bearing means that slidably engages one of the pair of parallel rails.

2) The apparatus of claim 1 wherein the at least one cradle is V-shaped and comprises two planar opposing wings angled downward toward the central axis of the support frame.

3) The apparatus of claim 2 wherein the two opposing wings are sloped at the same angle from horizontal and are spaced equidistantly from the central axis of the support frame at all corresponding points along their lengths.

4) The apparatus of claim 2 further comprising a frictional surface coating the two opposing wings.

5) The apparatus of claim 2 further comprising a surface topography on the two opposing wings.

6) The apparatus of claim 1 wherein the apparatus comprises more than one support member and more than one pair of rail bearing means.

7) The apparatus of claim 1 further comprising one or more support legs extending downward from the support frame.

8) The apparatus of claim 7 wherein the one or more support legs terminate in a wheel.

9) The apparatus of claim 7 wherein the one or more support legs are extendable.

10) The apparatus of claim 1 wherein the at least one cradle is permanently affixed to the support frame.

11) The apparatus of claim 10 wherein the at least one cradle is welded to the support frame.

12) The apparatus of claim 10 wherein the at least one cradle is riveted to the support frame.

13) The apparatus of claim 1 wherein the at least one cradle is selectively attachable to the support frame.

14) The apparatus of claim 13 wherein the at least one cradle is attached to the support frame by magnets.

15) The apparatus of claim 13 wherein the at least one cradle is bolted to the support frame.

16) The apparatus of claim 1 wherein the support frame is manufactured from a rigid material selected from the group consisting of wood, cement, metal, plastic and rubber.

17) The apparatus of claim 1 wherein the at least one cradle is manufactured from a rigid material selected from the group consisting of wood, cement, metal, plastic and rubber.
